(19) United States
(12) Patent Application Publication
(10) Pub. No.: US 2024/0288468 A1
(43) Pub. Date: Aug. 29, 2024

(54) METHOD OF AND SYSTEM FOR REFURBISHING A PROBE FOR USE IN A SCANNING PROBE MICROSCOPY DEVICE, AND A COMPUTER PROGRAM PRODUCT FOR PERFORMING SAID METHOD

(71) Applicant: Nearfield Instruments B.V., Rotterdam (NL)

(72) Inventor: Hamed SADEGHIAN MARNANI, Rotterdam (NL)

(21) Appl. No.: 18/572,344

(22) PCT Filed: Jun. 21, 2022
(86) PCT No.: PCT/NL2022/050356

§ 371 Date: Dec. 20, 2023

(30) Foreign Application Priority Data
Jun. 22, 2021 (NL) 2028509

(51) Int. Cl. G01Q 70/16; G01Q 30/02; G01Q 30/04; G01Q 70/08

(52) U.S. Cl. CPC G01Q 70/16; G01Q 30/025; G01Q 30/04; G01Q 70/08

(57) ABSTRACT

The invention is directed at a method of refurbishing a probe for use in a scanning probe microscopy device, wherein the probe is a used or damaged probe and includes a cantilever and a probe tip. The method comprises receiving the probe, determining an existing probe structure of the probe and mapping the existing probe structure for obtaining existing probe structure data. The method further includes identifying, based on the existing probe structure data, a deviation from an original probe structure of the probe prior to said using or damaging thereof. Based on the deviation, structural modification data indicative of a structural modification for modifying the probe will be determined, and, in accordance with the structural modification data, the existing probe structure will be modified by at least one of a precision material deposition process or precision material removal process, for performing said refurbishing of the probe. The method is further directed at a system and a computer program product for operating a system.

### BACKGROUND

Scanning probe microscopy (SPM) is an imaging technology that enables to provide images of on-surface and sub-surface structures at nanometer scale. The technology is non-optical and therefor is not diffraction limited, and as a result may for example be applied in semiconductor manufacturing processes, where structures of integrated circuits become so small that, due to being diffraction limited, optical imaging no longer suffices. Scanning probe microscopy, however, is likewise applied in other situations as a good alternative to optical imaging or scanning electron microscopy (SEM). The present document relates to SPM in general, and not particularly to it's application in any field of technology.

Scanning probe microscopy operates on the basis of a probe, having a cantilever and a probe tip (typically at the end of the cantilever), wherein the probe tip moves relative to a surface of a substrate while continuously or intermittently making contact therewith. With ‘contact’, it is meant here that the probe tip is brought at least in such a proximity to the surface that influence thereof is noticeable in the transfer function of the probes dynamic behavior. SPM is performed in various different modes, the most common modes being contact, intermittent contact and non-contact mode. In contact mode, the probe tip is kept in contact with the surface during scanning. If a structure on the surface is encountered, the probe tip is forced upward (e.g. a block) or falls downward (e.g. a trench). This change in probe tip deflection can be compensated in feedback, which enables to accurately determine the height or depth of the structure. In intermittent contact mode or tapping mode, the probe vibrates above the surface and intermittently touches the surface. A difference in deflection minimum (or maximum) is thereby indicative of a change in height or depth, which as well can be measured accurately using a compensating feedback loop that re-establishes the original minimum (or maximum). In non-contact mode, the probe tip is moved in very close proximity such as to encounter the influence of the surface onto the dynamic behavior of the probe.

The above shortly describes on-surface measurements, also referred to as surface topography measurements. For subsurface measurements, an ultrasonic vibration may further be applied to the probe or the sample or both, and the presence of subsurface features is detectable in resulting waves measurable at the surface, which also allows imaging thereof.

Whichever mode or technique is applied, probes used in SPM—the probe tips of which are typically very small and fragile—will quickly wear while performing imaging. This requires the probes to be replaced frequently. Furthermore, probes may become damaged in other ways or may in use attract contamination, e.g. from the surface of the substrate to be imaged. When used for long amounts of time, e.g. in a production process, the frequent replacement of used probes by new probes makes SPM costly to perform. Furthermore, the frequent replacements are not desired from an environmental point of view either, because each probe must be manufactured and transported to the location where it is to be used.

### SUMMARY OF THE INVENTION

It is an object of the present invention to enhance the durability of probes for use in scanning probe microscopy, and to reduce the amount of effort and energy spent in replacing probes in a scanning probe microscopy process.

To this end, in accordance with a first aspect of the invention, there is provided herewith a method of refurbishing a probe for use in a scanning probe microscopy device, wherein the probe is a used or damaged probe, the probe including a cantilever and a probe tip, wherein the method comprises: receiving the probe; determining an existing probe structure of the probe and mapping the existing probe structure for obtaining existing probe structure data; identifying, based on the existing probe structure data, a deviation from an original probe structure of the probe prior to said using or damaging thereof; determining, based on the deviation, structural modification data indicative of a structural modification for modifying the probe; and modifying, in accordance with the structural modification data, the existing probe structure by applying a precision material deposition process, for performing said refurbishing of the probe. In accordance with some embodiments thereof, in the method of the invention, the step of modifying the existing probe structure may further comprise applying a precision material removal process, for performing said refurbishing of the probe.

The invention provides a method of refurbishing (repairing) a used or damaged probe, and thereby anticipates the necessity to completely replace it. Furthermore, the present method can be performed completely on-site and therefore enables an efficient replacement method. For example, in an industrial setting, where probes are to be replaced very frequently and ongoing, it becomes possible to work with a pool of probe chips including probes, e.g. distributed over multiple cassettes. While one of the cassettes is used at the SPM system, from where replacement probes can be picked up in use, the probes in another cassette which are used and replaced may be refurbished using a method of the present invention. The SPM system is thereby allowed to continuously operative, and the probes are constantly refurbished. This can be continued until further refurbishment of one or more probes is no longer feasible, in which case only these few probes need to be replaced by new ones. The invention is based on the insight that conventionally there is no method available to refurbish probes, and thereby provides substantive advantages by foreseeing therein—in terms of efficiency and durability.

In particular, the present invention allows for excellent control of the repairing process. By determining the existing probe structure and mapping thereof, it becomes possible to identify a deviation from an original probe structure of the probe which deviation may optionally be stored as deviation data or directly used for determining structural modification data. Hence, any damage to the probe tip or cantilever may accurately be determined, as well as the shape or nature of such structural damage. For example, if a dust particle or substrate fragment is present on the probe tip, the shape thereof can be determined and the contamination may be precisely removed. As a result the method allows to restrict the repairs, where desired, to nothing more than just the contamination. In another example, if the apex of the probe tip is lost due to wear, the shape thereof can be precisely reconstructed: either by comparing it with the original design of the probe tip or, in case of more standard or regular tip shapes, by extrapolation of the existing edges or by projecting a desired tip shape onto the damaged parts. Therefore, in accordance with some embodiments, the step of determining the structural modification data comprises a step of determining a location or shape of a damage on the probe, such as a fractured part or a damage caused by wear or contamination.

Referring to the above examples, the step of determining a deviation and the step of determining structural modification data may be performed in different ways. Furthermore, it may be performed as one integrated process or as several steps. For example, in some embodiments, the step of identifying a deviation comprises obtaining a probe structure design data indicative of an original probe structure design; and comparing the existing probe structure data with the probe structure design data for performing said identification. Where the original probe structure design is known or may be reproduced, this method enables to exactly identify the deviation and model the shape thereof such as to provide structural modification data. In other or further embodiments, the step of identifying a deviation comprises analyzing the existing probe structure data for estimating an expected original probe structure design, and comparing the existing probe structure data with the expected original probe structure design for performing said identification. This step requires less data storage capacity and may be performed relatively fast using e.g. pattern recognition algorithms or extrapolation, which may therefore be useful with more standard or regularly shaped probe tips, for example. In some of these latter embodiments, the analyzing is performed by at least one of: extrapolation of probe tip edges such as to determine an expected location of an apex of a probe tip in an expected original probe structure design; applying a trained machine learning data processing model perform said estimating; or comparing the existing probe structure data with one or more different types of standard probe structure designs for determining a similarity and estimating the expected original probe structure design based on said similarity.

In accordance with some embodiments, the precision material deposition process is an electron beam deposition (EBD) process. This process may be precisely controlled to perform the repairs in accordance with the determined structural modification data, by depositing material only there where desired. Control is achievable by precise focusing of the beam onto the areas of the probe where material needs to be deposited, and controlling parameters such as intensity, beam diameter and angle of incidence of the electron beam on the probe in order to respectively control the deposition speed, deposition area and growing direction of deposited material. Beam control instructions may be predetermined on the basis of the structural modification data, or may be controlled on the fly by monitoring the process e.g. using an optical microscope.

Similarly, in accordance with some embodiments, the precision material removal process is a focused ion beam (FIB) process. FIB systems use a finely focused beam of ions (usually gallium) that can be operated at high beam currents for site specific milling. Similar to the above, control may be achieved by precise focusing of the beam onto the areas of the probe where material needs to be removed, and controlling parameters such as intensity, beam diameter and angle of incidence of the ion beam on the probe in order to respectively control the milling speed, milling area and removal direction. By combining both EBD with FIB, in accordance with some embodiments, repairs may be conducted that precisely follow the determined structural modification data.

In some embodiments, the step of receiving the probe comprises obtaining, from a probe chip cassette, a probe chip including the probe. As briefly explained above, this conveniently enables to inter alia perform the method alongside or near the scanning probe microscopy process, wherein cassettes of used or damaged probes are provided to a probe refurbishment unit or system while the SPM system is provided with a cassette of replacement probes for replacement in use. The used probes are refurbished from the cassette with used probes, while simultaneously the SPM continues to operate using a separate cassette of new or refurbished probes.

In some embodiments, the step of determining the existing probe structure comprises: obtaining an image of the probe tip or the cantilever; and performing a pattern recognition algorithm for enabling said mapping of the existing probe structure for obtaining the existing probe structure data. Various imaging techniques may be used for this. However, in some embodiments, the image is obtained using at least one of an optical microscope or a scanning electron microscope. An optical microscope suffices in terms or accuracy, is efficient and has a conveniently small form factor.

In accordance with some embodiments, the step of determining the structural modification data comprises determining one or more parts of the probe to be added or removed during the step of modifying. This allows used probes to be refurbished and additionally modified to perform other functions. For example, regular cone shaped probe tips may be transformed into high aspect ratio probe tips, hammerhead probe tips, or even probe tip arrays comprising multiple tips. In these embodiments, the step of determining the one or more parts to be added or removed may in some cases comprise determining a shape of said one or more parts to be added or removed. This can be used to provide additional data to be included in the structural modification data. Therefore, in accordance with some embodiments, the method further comprises obtaining modified design data indicative of one or more further modifications of the original probe structure design; and the step of determining structural modification data comprises using the modified design data in addition to the deviation, for determining the structural modification data such as to include the one or more further modifications.

In accordance with a second aspect of the invention, there is provided a system for refurbishing a used or damaged probe for use in a scanning probe microscopy device, the probe including a cantilever and a probe tip, wherein the system comprises a probe capture unit for capturing the probe, an imaging unit for obtaining an image of the probe, and a controller cooperating with a memory or data storage, wherein the controller is configured for performing the steps of: determining an existing probe structure of the probe and mapping the existing probe structure for obtaining existing probe structure data; identifying, based on the existing probe structure data, a deviation from an original probe structure of the probe prior to said using or damaging thereof; determining, based on the deviation, structural modification data indicative of a structural modification for modifying the probe for enabling said refurbishing thereof; wherein the system further comprises a precision material deposition unit configured for performing said structural modification, wherein the controller is configured for cooperating with the precision material deposition unit for modifying, in accordance with the structural modification data, the existing probe structure by the precision material deposition unit, for performing said refurbishing of the probe. In accordance with some embodiments thereof, the system may further comprise a precision material removal unit configured for performing said structural modification, wherein the controller is further configured for cooperating with the precision material removal unit for modifying, in accordance with the structural modification data, the existing probe structure by the precision material removal unit, for performing said refurbishing of the probe.

In accordance with a third aspect of the invention, there is provided a computer program product comprising instructions to cause the system in accordance with the second aspect to execute the steps of the method of the invention in accordance with the first aspect. In accordance with a fourth aspect of the invention, there is provided a computer-readable medium having stored thereon the computer program in accordance with the third aspect.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIG. 1 schematically illustrates a system in accordance with an embodiment of the invention;

FIG. 2 schematically illustrates a method in accordance with an embodiment of the invention;

FIG. 3 schematically illustrates an example of probe tip refurbishment;

FIGS. 4a to 4c schematically illustrate an example of a modification of a probe using a method in accordance with the present invention;

FIG. 5 schematically illustrates a further example of probe tip refurbishment.

FIG. 6 schematically illustrates a probe chip for use in embodiments of the present invention.

### DETAILED DESCRIPTION

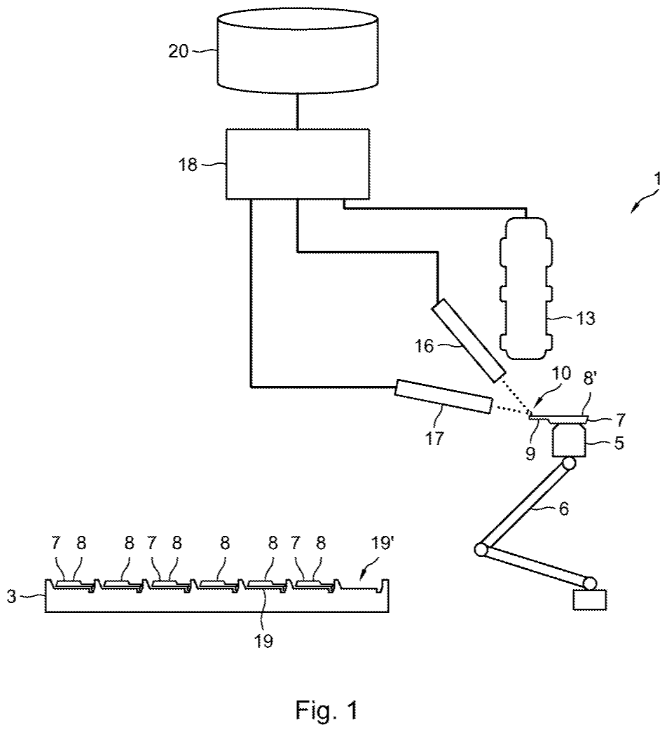

FIG. 1 schematically illustrates a probe refurbishment system 1 in accordance with an embodiment of the present invention, suitable for carrying out a method in accordance with an embodiment of the present invention. The system 1 presented in FIG. 1 is depicted including a robotic arm 6 with probe chip manipulator 5, which enables to pick probe chips 7 including probes 8 from a cassette 3. The cassette 3 in the embodiment illustrated serves as transport carrier for the used probe chips 7 As may be appreciated, the use of a robotic arm 6 with manipulator 5 is completely optional to the system. In systems in accordance with embodiments of the invention, probes 8 may likewise be loaded into the system in a different manner.

The system 1 as illustrated in FIG. 1 further comprises an optical microscope 13 for imaging probes, such as probe 8′ loaded into the system 1. Furthermore, an electron beam deposition (EBD) unit 16 and a focused ion beam (FIB) unit 17 may be present to enables precision modification of a probe, i.e. a precision material deposition process or a precision material removal process. These units 16 and 17 are controlled by the system 1, which includes a controller 18 and is communicatively connected with a data storage 20. The data storage 20 may be any kind of data storage, such as an on-board memory in the system 1, or a remote data repository that can be accessed via a data communications network. A computer program stored in memory 20 and running on system 1, enables the controller 18 to operate the robot arm 5 with manipulator 5, the microscope 13, the EBD unit 16 and the FIB unit 17. In other embodiments, also the precision material deposition unit 16 may be provided by a focused ion beam deposition unit. In these embodiments, the units 16 and 17 may be different units or may be integrated into a single unit applying a focused ion beam for both deposition and removal. The skilled person will be aware of how to implement this.

The embodiment illustrated in FIG. 1 merely is an example of a system. Alternatively, the system 1 may comprise a loading dock for the cassette 3, from which a manipulator picks up the probes 8. Such a manipulator does not need to be a robot arm, as in FIG. 1. Furthermore, a different imaging system 13 may be applied suitable for accurately imaging the probe 8′, cantilever 9 and probe tip 10. For example, a scanning electron microscope (SEM) of other type of imaging means may be applied for this. Also, the system 1 of the present invention is not restricted to applying an electron beam deposition (EBD) unit 16 and a focused ion beam (FIB) unit 17 as precision material manipulation processes.

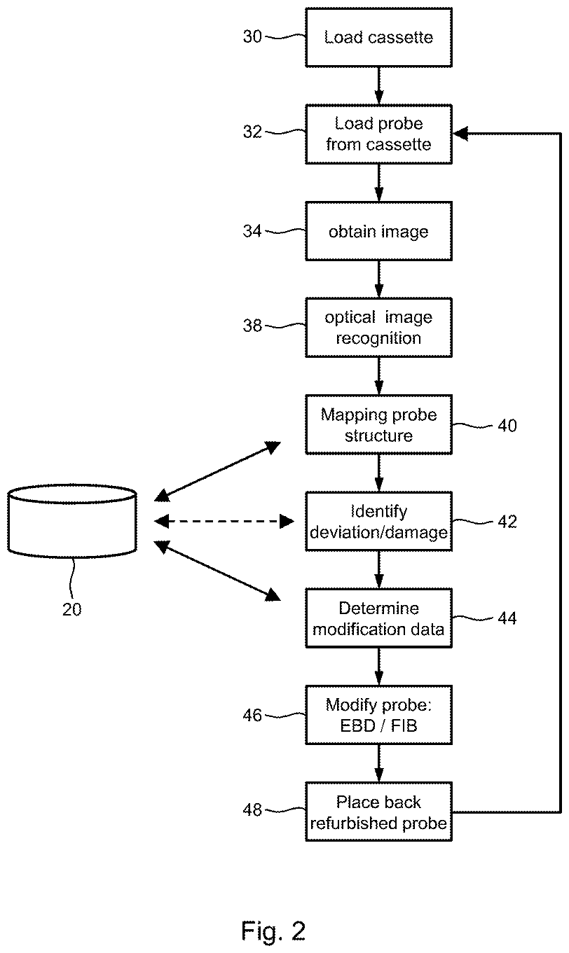

In FIG. 1, the system 1 has been loaded with a probe 8′ obtained from cassette 3. The cassette 3 comprises a plurality of cradles 19, in each of which a used probe 8 may reside. Cradle 19′ of cassette 3 is empty, and indicates the location from which probe 8′ has been obtained by the manipulator 5. To refurbish probe 8′, the system 1 applies a method in accordance with an embodiment of the present invention. Such a method is schematically illustrated in FIG. 2 in accordance with an embodiment.

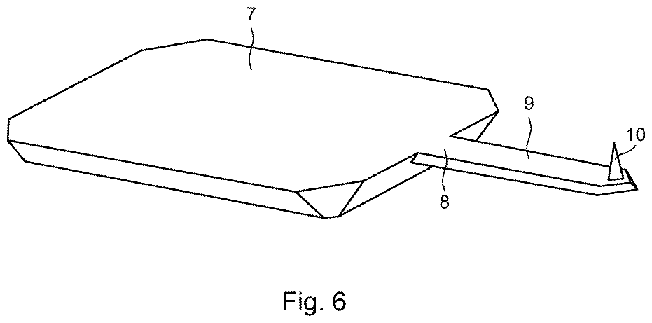

An example of a probe chip 7 is schematically illustrated in FIG. 6. The probe chips 7 illustrated in FIG. 1 may for example have a similar design, although the probe chip 7 in FIG. 6 is only an example and many different shapes and structures of probe chips are available for scanning probe microscopy, and application of methods and systems in accordance with embodiments of the invention is not limited to certain specific types of probe chips 7. The example in FIG. 6 has been added in order to discuss various known design parameters and dimensions of probes 8, without being limited thereto. The probe chip 7 in FIG. 6 serves as carrier element for a probe 8 which comprises a cantilever 9 and a probe tip 10. The holder or carrier element, i.e. the main body of probe chip 7, may have a length and width of several millimeters for easy handling and mounting thereof by and in the SPM system or by the probe refurbishment system 1 of the invention. For example, the probe chip 7 of FIG. 6 has macroscopic dimensions of 1.6*3.4 mm² (square millimeters). The cantilever 9 consists of a beam with dimensions in the following ranges: length of 50 to 500 μm (micrometer), width of 20 to 50 μm (micrometer) and thickness of 0.4 to 8 μm (micrometer). The cantilever is configured for operating at spring constants of within a range of 0.01 to 50 N/m at these lengths, and the resonance frequency ranges between 1 kilohertz to 1 megahertz. The probe tip 10 has a cross section smaller than 30 nm (nanometer) and a tip height below 30 nm (nanometer), preferable between 3 nm (nanometer) and 20 nm (nanometer). The shape of the tip 10 may differ dependent on the application wherein SPM needs to be performed. Furthermore, the material of the probe chip 7 may be selected dependent on the needs. In the illustrated example, this is single crystalline silicon or silicon nitride thin film.

In FIG. 2, a method in accordance with an embodiment of the invention commences with step 30 wherein a cassette 3 is loaded into a system 1. As may be appreciated, although in the present embodiment the probe chips 7 serving as carrier elements of the probes 8 are provided to the system 1, in step 30, via a cassette 3 wherein the chips 7 reside (e.g. as illustrated in FIG. 1). Alternatively, the chips 7 may be provided in a different manner, for example it is also possible to convey the chips 7 after use thereof directly from an SPM system into the probe refurbishment system 1 using a suitable transport mechanism. Also, a different type of transport carrier 3 may be used.

The cassette 3 includes an arbitrary number of cradles 19, some or all of which may be filled for holding one or more probe chips 7 including probes 8 (each cradle 19 typically holds a single probe 8). In step 32, one of the probes 8′ is loaded into the probe refurbishment system 1 for refurbishing thereof. This may be achieved using a robotic arm 6 including a manipulator 5, or by means of a different transport mechanism. For example, it is not required to apply a transport mechanism that provides all the degrees of freedom of movement that are provided by the robotic arm 6. In a different design of the system, transport mechanism may merely enable a relative translation between the probe 8 and the functional units of the system (e.g. the microscope 13 (imaging unit), EBD unit 16 and/or FIB unit 17); or a translation and a rotation, or movement in two translational directions with or without one or more rotational degrees of freedom. Once loaded, the probe 8′ is held in system 1 in such a manner as to at least allow imaging thereof by optical microscope 13.

In step 34, such an image is obtained and may be stored as imaging data for further analysis in the memory 20. In the system of FIG. 1, the imaging unit 13 is an optical microscope 13, but instead a different type of imaging unit may be applied. Then in step 38, an optical image recognition process may be applied to the imaging data in order to determine the existing probe structure of the probe 8′. The image obtained in step 34 may be a single image, however typically, to enable three dimensional analysis of the probe 8′ and e.g. any structural damage to probe tip 10 or cantilever 9, multiple images may be obtained with microscope 13 in step 34. The multiple images may in turn be processed in step 38 to determine the existing three dimensional probe structure of the probe 8′.

The data obtained from step 38 is used in step 40 to perform a mapping of the existing probe structure of probe 8′, and to provide existing probe structure data that may be stored in the memory 20. If multiple images have been analyzed in step 38, the data of these images is used in order to perform the mapping in step 40. Thereafter, in step 42, a deviation from an original probe structure of the probe 8′ prior to said using by the SPM system or prior to damaging thereof may be identified. This can be done in different ways. In one embodiment, the mapped existing probe structure data from memory 20 may be analyzed by controller 18 to identify the deviations. For example, if a probe tip 10 has a regular design such as a common cone or pyramid type of structure, the remaining edges and sides of the structure may be extrapolated to guestimate the location of the original apex of the tip, i.e. the location where the apex of the tip used to be prior to wearing off in use in the SPM system. Alternatively, it is also possible that the original design of the probe structure of probe 8′ is obtained from the memory 20. For example, the probe structure design data therefor may have been obtained from a manufacturer of the probe 8′. If this data from the manufacturer may not be available, a new and undamaged probe 8 of the same type may be imaged in the probe refurbishment system 1 in order to determine the original probe structure design data. In another alternative, this original probe structure design data may be obtained by loading the probe 8′ into probe refurbishment system 1 while it is not yet used, so prior to loading thereof in the SPM system. For example, in an industrial setting, a probe cassette 3 with new probes may first be loaded into the probe refurbishment system 1 in order to map the structure of each probe 8 and to provide original probe structure design data associated with each probe 8 to be stored in the memory 20. Thereafter, the complete cassette 3 with all probes 8 is provided to the SPM system for use thereof. When all probes 8 have been used, the cassette 3 is again loaded into the probe refurbishment system 1 which then performs the above steps 30 to 42 to identify the deviations due to wear or damage of the probes 8, fur repairing thereof.

In addition to the above, it is also possible in accordance with some embodiments, that the method further includes a step of obtaining modified design data indicative of one or more further modifications of the original probe structure design. These further modifications for example may relate to additional structural features that may be added to the probes 8, if desired. For example, a probe tip 10 may be modified to become a high aspect ratio (HAR) tip, or additional probe tips 10 may be added to form an array. Many different types of further modifications are possible in this respect.

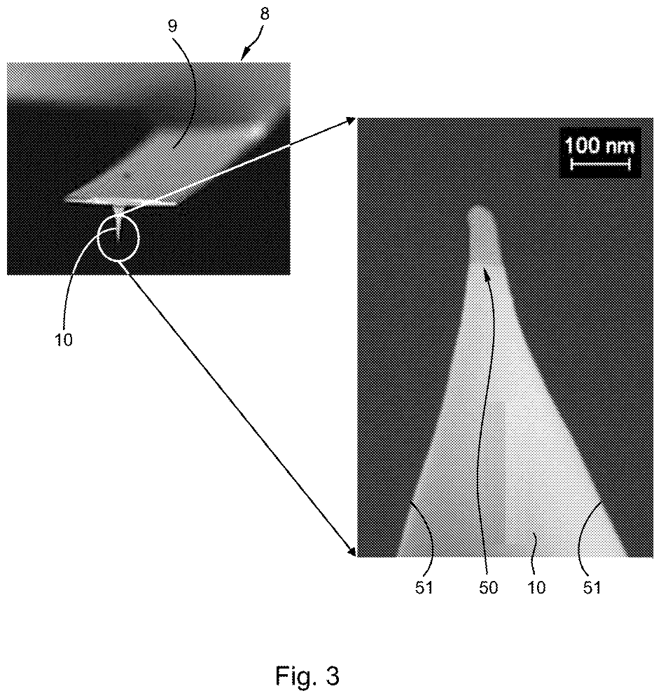

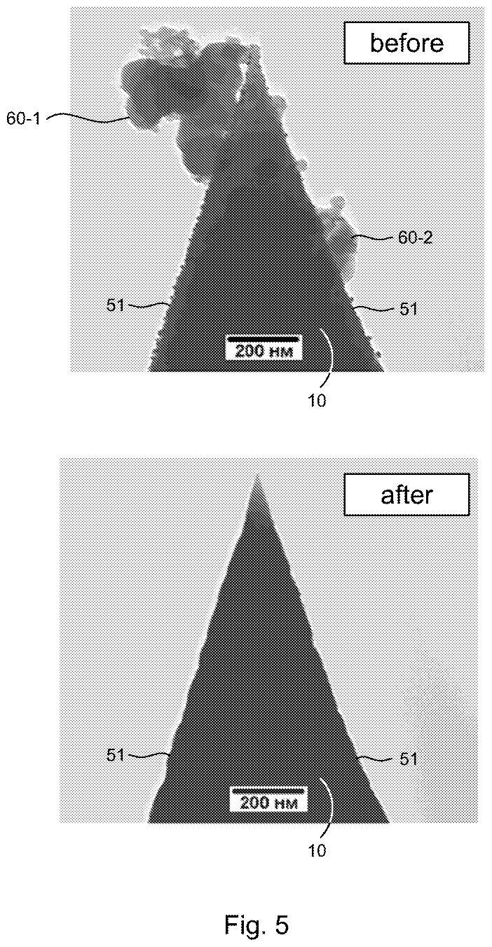

In step 44, based on the determined deviations in step 42, structural modification data is determined. This step may for example comprise determining one or more parts of the probe to be added or removed during the step of modifying. For example, a shape of said one or more parts to be added or removed may be determined. As may be appreciated, probe tips 10 may wear off in use, such that the apex thereof flattens or smoothens. Additionally or alternatively, the probe tip 10 may have attracted dirt particles that adhere to the tip, or the probe tip 10 may have become damaged upon encountering an edge of a relatively hard material. In any of these cases, the used probe 8 deviates from the original probe structure design such that some material has disappeared (e.g. in case of wear or damage) and some material is present where it should not be present (e.g. in case of contamination or damage). Step 44 of determining the structural modification data, in that case may comprise a step of determining a location or shape of a damage on the probe 8, in particular on the probe tip 10 or in some cases the cantilever 9, such as a fractured part or a damage caused by wear or contamination. Examples of such deviation are illustrated in FIGS. 3 and 5, although it will be appreciated that deviations may manifest itself in many different ways, shapes, forms and levels of severeness.

FIG. 3 shows an image of a probe 8 having a cantilever 9 and probe tip 10. The right side of the figure shows an enlargement of the probe tip 10 wherein the remaining side walls 51 are clearly visible. At the apex of the probe tip 10, a dark colored part indicates the location and shape of a fractured part 50. The fractured part 50 thereby forms the deviation from the original probe structure shape, which may be modelled in steps 42 and 44 and stored as structural modification data. The probe tip 10 can be restored, including the missing part 50 thereof, by means of electron beam deposition using an EBD unit 16.

In another example, in FIG. 5, an image of a probe tip 10 is shown which also clearly shows the side walls 51 of the tip 10. In the left part of FIG. 5, the probe tip 10 is shown having dirt particles 60-1 and 60-2 adhered to the sides thereof. The right side image of FIG. 5 illustrates the same probe tip 10 after refurbishment thereof using a system 1 in accordance with an embodiment of the invention. The side walls 51 are restored, and the dirt particles 60-1 and 60-2 have been removed with a focused ion beam using FIB unit 17.

As already suggested above, back to FIG. 2, the method and system in accordance with embodiments of the invention may also be applied in order to add further modifications to the probe 8 and probe tip 10 possible. For example, the step 44 of determining structural modification data may include a step of obtaining modified design data indicative of one or more further modifications of the original probe structure design, which for example may relate to additional structural features that may be added to the probes 8. This is additional step is optional. For example, this may include the further modification of the shape of the probe tip 10. The step 44 of determining structural modification data in that case may comprise using the modified design data, e.g. from memory 20, in addition to the deviation or deviation data for determining the structural modification data to include therein the one or more further modifications.

Once the structural modification data is made available, e.g. stored in memory 20, it can be used in step 46 to modify the existing probe structure in order to perform the refurbishment of the probe 8. For example, an EBD unit may be used to repair a missing part of the probe tip 10 that is worn off in use of the probe 8. The EBD unit may also be applied in order to grow additional structures, such as a HAR whisker, a side lobe of the tip 10, or an additional tip next to the original probe tip 10. Furthermore, the FIB unit may be used to remove undesired structures, e.g. dirt particles or parts of the probe that are bent or otherwise form undesired structures on the side walls 51 of the tip 10.

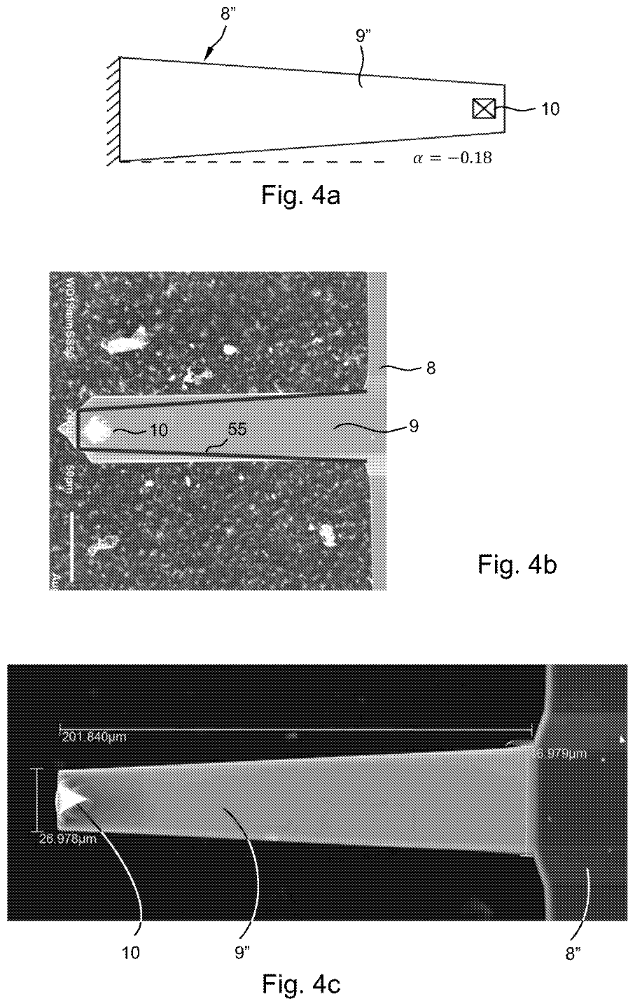

If further modification of the probe 8 is desired, this as well may be performed in step 46. For example, a further modification is illustrated in FIGS. 4a to 4c. In FIG. 4a, the layout of a desired probe structure of probe 8″ is illustrated. The probe tip 10 is to be maintained as in the original probe structure design, but the shape of the cantilever 9 is to be modified into 9″ illustrated in FIG. 4a, for example to improve the dynamic behavior. FIG. 4b shows an image of the original probe 8 with cantilever 9 and probe tip 10. The lines 55 indicate the edges of the parts of the cantilever 9 that need to be removed in order to obtain the modified design 9″. The material of the cantilever 9 can be cut using a focused ion beam, as explained hereinabove. This will yield the probe design of FIG. 4c, showing probe 8″ with cantilever 9″ and probe tip 10, similar to the design shown in FIG. 4a.

Returning to FIG. 2, if the probe 8 has been refurbished (e.g. the probe 8′ of FIG. 1), it will be placed back in the cassette 3 (or other transport carrier) in step 48. Thereafter, the system may determine whether a further probe needs to be refurbished from cassette 3, or whether the probes 8 in cassette 3 have all been refurbished. If a new probe 8 is to be obtained from the cassette 3, the method returns to step 32. Otherwise, the method may end after step 48.

The present invention has been described in terms of some specific embodiments thereof. It will be appreciated that the embodiments shown in the drawings and described herein are intended for illustrated purposes only and are not by any manner or means intended to be restrictive on the invention. The context of the invention discussed here is merely restricted by the scope of the appended claims.

1. A method of refurbishing a probe for use in a scanning probe microscopy device, wherein the probe is a used or damaged probe, the probe including a cantilever and a probe tip, wherein the method comprises:
receiving the probe;
determining an existing probe structure of the probe and mapping the existing probe structure for obtaining existing probe structure data;
identifying, based on the existing probe structure data, a deviation from an original probe structure of the probe prior to said using or damaging thereof;
determining, based on the deviation, structural modification data indicative of a structural modification for modifying the probe; and
modifying, in accordance with the structural modification data, the existing probe structure using a precision material deposition process, for performing said refurbishing of the probe.

2. The method according to claim 1, wherein the step of modifying the existing probe structure further comprises applying a precision material removal process, for performing said refurbishing of the probe.

3. The method according to claim 1, wherein the step of identifying a deviation comprises:
obtaining a probe structure design data indicative of an original probe structure design; and
comparing the existing probe structure data with the probe structure design data for performing said identification.

4. The method according to claim 1, wherein the step of identifying a deviation comprises analyzing the existing probe structure data for estimating an expected original probe structure design, and comparing the existing probe structure data with the expected original probe structure design for performing said identification.

5. The method according to claim 4, wherein said analyzing is performed by at least one of:
extrapolation of probe tip edges such as to determine an expected location of an apex of a probe tip in an expected original probe structure design;
applying a trained machine learning data processing model perform said estimating; or
comparing the existing probe structure data with one or more different types of standard probe structure designs for determining a similarity and estimating the expected original probe structure design based on said similarity.

6. The method according to claim 1, wherein the step of receiving the probe comprises obtaining, from a probe chip cassette, a probe chip including the probe.

7. The method according to claim 1, wherein the step of determining the existing probe structure comprises:
obtaining an image of the probe tip or the cantilever; and
performing a pattern recognition algorithm for enabling said mapping of the existing probe structure for obtaining the existing probe structure data.

8. The method according to claim 7, wherein the image is obtained using at least one of: an optical microscope or a scanning electron microscope.

9. The method according to claim 1, wherein the step of determining the structural modification data comprises determining one or more parts of the probe to be added or removed during the step of modifying.

10. The method according to claim 9, wherein the step of determining the one or more parts to be added or removed comprises determining a shape of said one or more parts to be added or removed.

11. The method according to claim 1, wherein the step of determining the structural modification data comprises a step of determining a location or shape of a damage on the probe, such as a fractured part or a damage caused by wear or contamination.

12. The method according to claim 1, wherein the method further comprises:
obtaining modified design data indicative of one or more further modifications of the original probe structure design; and
wherein the step of determining structural modification data comprises using the modified design data in addition to the deviation, for determining the structural modification data such as to include the one or more further modifications.

13. The method according to claim 1, wherein at least one of:
the precision material deposition process is an electron beam deposition process; or
the precision material removal process is a focused ion beam process.

14. A system for refurbishing a used or damaged probe for use in a scanning probe microscopy device, the probe including a cantilever and a probe tip, wherein the system comprises a probe capture unit for capturing the probe, an imaging unit for obtaining an image of the probe, and a controller cooperating with a memory or data storage, wherein the controller is configured for performing the steps of:
determining an existing probe structure of the probe and mapping the existing probe structure for obtaining existing probe structure data;
identifying, based on the existing probe structure data, a deviation from an original probe structure of the probe prior to said using or damaging thereof;
determining, based on the deviation, structural modification data indicative of a structural modification for modifying the probe for enabling said refurbishing thereof;
wherein the system further comprises a precision material deposition unit configured for performing said structural modification,
wherein the controller is configured for cooperating with the precision material deposition unit or precision material removal unit for modifying, in accordance with the structural modification data, the existing probe structure by the precision material deposition unit, for performing said refurbishing of the probe.

15. The system according to claim 14, wherein the system further comprises a precision material removal unit configured for performing said structural modification,
wherein the controller is further configured for cooperating with the precision material removal unit for modifying, in accordance with the structural modification data, the existing probe structure by the precision material removal unit, for performing said refurbishing of the probe.

16. The system according to claim 14, wherein for identifying the deviation, the controller is configured for:
obtaining, from the memory or data storage, a probe structure design data indicative of an original probe structure design; and
comparing the existing probe structure data with the probe structure design data for performing said identification.

17. The system according to claim 14, wherein for identifying the deviation, the controller is configured for analyzing the existing probe structure data for estimating an expected original probe structure design, and for comparing the existing probe structure data with the expected original probe structure design for performing said identification.

18. The system according to claim 17, wherein for performing said analyzing the controller is configured for at least one of:
extrapolation of probe tip edges such as to determine an expected location of an apex of a probe tip in an expected original probe structure design;
applying a trained machine learning data processing model perform said estimating; or
comparing the existing probe structure data with one or more different types of standard probe structure designs for determining a similarity and estimating the expected original probe structure design based on said similarity.

19. The system according to claim 14, wherein the probe capture unit is configured for obtaining, from a probe chip cassette, a probe chip including the probe.

20. The system according to claim 14, wherein the imaging unit is at least one of: an optical microscope or a scanning electron microscope.

21. The system according to claim 14, wherein the precision material deposition unit is at least one of a group comprising: an electron beam deposition unit, and ion beam deposition unit or focused ion beam deposition unit.

22. The system according to claim 14, wherein the precision material removal unit is a focused ion beam unit.

23. A computer program product comprising instructions to cause a controller of a system to execute the steps of the method of claim 1,
wherein the system is for refurbishing a used or damaged probe for use in a scanning probe microscopy device, the probe including a cantilever and a probe tip, wherein the system comprises a probe capture unit for capturing the probe, an imaging unit for obtaining an image of the probe, and said controller cooperating with a memory or data storage.

24. A non-transitory computer-readable medium having stored thereon the computer program of claim 23.
